(19) United States
(12) Patent Application Publication
(10) Pub. No.: US 2004/0258838 A1
(43) Pub. Date: Dec. 23, 2004

(54) Method for preserving wood materials using precipitated copper compounds

(76) Inventors: H. Wayne Richardson, Sumter, SC (US); Robert L. Hodge, Sumter, SC (US)

Correspondence Address: MORGAN LEWIS & BOCKIUS LLP, 1111 PENNSYLVANIA AVENUE NW, WASHINGTON, DC, 20004, US

(21) Appl. No.: 10/868,938

(22) Filed: Jun. 17, 2004

Related U.S. Application Data
(60) Provisional application No. 60/478,824, filed on Jun. 17, 2003.
(60) Provisional application No. 60/478,823, filed on Jun. 17, 2003.

(51) Int. Cl. B05D 3/00

(52) U.S. Cl. 427/238; 427/297; 427/291

(57) ABSTRACT

The invention provides a method of preserving wood. The method involves applying to a wood substrate a precipitated copper salt. The precipitated copper salt is formed from a solution containing a copper-alkanolamine complex. The precipitated copper salt can be formed in situ, i.e., after the solution containing a copper-alkanolamine complex is applied to the wood, or prior to being applied to the wood.

### RELATED APPLICATIONS

The present application claims priority to pending U.S. provisional application No. 60/478,824 filed on Jun. 17, 2003, the contents of which are incorporated herein by reference thereto, and also to pending U.S. provisional application No. 60/478,823 filed on Jun. 17, 2003, the contents of which are also incorporated herein by reference thereto.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### SEQUENCE LISTING

Not Applicable

1. Field of the Invention

The present invention relates to wood preservatives, particularly wood preservatives comprising one or more soluble copper-amine compounds. More particularly, the present invention relates to methods of forming precipitates from aqueous compositions having soluble copper-ammonia complexes and/or soluble copper-monoethanolamine complexes, wherein the precipitates are injectable into or formed in the wood.

2. Background of the Invention

The production of wood which has been treated to inhibit biological decomposition is well known. Decay is caused by fungi that feed on cellulose or lignin of wood. Such organisms causing wood decomposition include: basidiomycetes such as Gloeophyllum trabeum (brown rot), Trametes versicolor (white rot), Serpula lacrymans (dry rot) and Coniophora puteana. Soft rot attacks the surface of almost all hard and softwoods, and it favors wet conditions. Most of these fungi require food and moisture, e.g., moisture contents in wood of greater than 20% are conducive to fungal growth. Dry rot is tenacious, as it can grow in dry wood. Insects are also major causes of wood deterioration. Exemplary organisms causing wood decomposition include coleopterans such as Anobium punctatum (furniture beetle), Hylotrupes bajulus (house longhorn) and Xestobium rufovillorum (death watch beetle); hyrnenopterans such as termites and carpenter ants; and also by marine borers and/or wasps. Finally, termites are ubiquitous, and termite damage is estimated in the United States alone to be about $2 billion per year.

The primary preserved wood product has historically been southern pine lumber treated with chromated copper arsenate (CCA). Most of this treated lumber was used for decks, fencing and landscape timbers. Concerns have recently been raised about the safety and health effects of CCA as a wood preservative, primarily relating to the arsenic content but also to the chromium content. In 2003/2004, due in part to regulatory guidelines and to concerns about safety, there has been a substantial cessation in the use of CCA-treated products. The production of wood based composite products has increased dramatically in recent years. Oriented strandboard (OSB) production exceeded that of plywood in 2000. The use of medium density fiberboard and hardboard panel products likewise has increased dramatically over the last couple of decades. However, these products are typically used in interior applications where attack from insects or decay fungi is limited, because it has been found that these products are particularly susceptible to attack by biological agents such as fungi and termites.

A new generation of copper-containing wood preservatives uses one or more forms of soluble copper(II). Known preservatives include copper alkanolamine complexes, copper polyaspartic acid complex, alkaline copper quaternary, ammoniacal copper quaternary, ammoniacal copper zinc, copper azole, copper boron azole, copper bis(dimethyldithiocarbamate), ammoniacal copper citrate, copper citrate, and the copper alkanolamine carbonate complexes, particularly copper monoethanolamine carbonate. Of the many compositions listed above, substantially all contain soluble copper as either a copper-amine complex, a copper alkanolamine complex, or a copper ammonium complex. U.S. Pat. No. 6,646,147 to Richardson et al., the disclosure of which is incorporated herein by reference, discloses a cost-effective process for producing aqueous copper-monoethanolamine solutions. In practice the principal criteria for commercial acceptance, assuming treatment efficacy, is usually cost. The only commercially accepted treatments have either the copper monoethanolamine complex (typically manufactured by the process disclosed in U.S. Pat. No. 6,646,147) or the copper ammonium complex.

Leaching data suggest that the copper(II)-monoethanolamine and the copper(II)-ammonia are fixated in the wood in a process that also fixes a substantial portion, if not most, of the monoethanolamine or the ammonia, respectively. These new copper(II) complex-containing wood preservatives are not without problems, however.

For instance, these soluble copper(II)-complex-containing preservatives are sufficiently mobile so as to be spontaneously leached from the wooden substrate at much faster rates than CCA. Indeed, as indicated by one study, as much as 80 percent of the copper from a copper amine (NH₃) carbonate complex is removed in about 10 years under a given set of field conditions. Under severe conditions, such as the those used for the American Wood Preserving Association's (AWPA) standard leaching test, these new copper-containing wood preservatives are quickly leached from the wood. For example, under non-AWPA standard conditions we found that 77% by weight of a copper monoethanolamine carbonate preservative was leached from preserved wood in 14 days. Another study, following the Synthetic Precipitation Leaching Procedure, reported that leachate from CCA-treated wood contained about 4 mg copper per liter; leachate from copper boron azole-treated wood contained about 28 mg copper per liter; leachate from copper bis(dimethyldithiocarbamate) treated wood had 7 to 8 mg copper per liter; leachate from alkaline copper quaternary treated wood had 29 mg copper per liter; and leachate from copper citrate treated wood had 62 mg copper per liter. Higher copper concentrations in the leachate result are indicative of high rates of copper depletion over time. While certain compounds, such as dimethyldithiocarbamate, can reduce leaching, their cost can not justify their use. The leaching from the ammoniacal copper and the copper(II)-monoethanolamine-treated substrates compromises the long term efficacy of the formulation, and may also increase the cost as manufacturers increase the amount of the copper compound in the wood, i.e., the copper loading, usually expressed in pounds of copper per cubic foot. The AWPA Retention Standards for CBA-A are from 0.20 to 0.61 pounds per cubic foot, for example, but even at the highest concentration the wood is not recommended for aqueous environments.

Leaching is also of concern because the leached copper can contaminate the environment, especially aquatic environments. While most animals tolerate copper, copper is extremely toxic to fish at levels below 1 part per million (essentially 1 milligram per liter). Common EC₅₀ values for copper are between 2 and 12 micrograms per liter. Copper leaching is such a problem that some states do not allow the use of wood treated with the soluble copper containing wood preservatives near waterways. The leaching of copper preservatives can be controlled by using, for example, an oil barrier. But these oils can unfavorably change the color, appearance, and burning properties of the wood, and can be strong irritants. Oil-soaked wood containing oil-soluble biocides like chlorothalonil, e.g., utility poles, are highly resistant to leaching and biological attack, but the appearance of this wood is not acceptable for most uses.

These preservatives are also more expensive than the CCA formulations on a pound-for-pound basis. A large part of the cost is the solvent, e.g., the alkanolamine and the ammonia. It takes between three and four molecules of the alkanolamine or ammonia to complex and solvate one copper (II) ion. Ammonia is typically less expensive than an alkanolamine, and it is commonly used in many western states. Monoethanolamine is preferred in the eastern US, most likely because it does not have the odor, irritating fumes, and phytosensitivity associated with ammonia.

The commercial soluble copper(II) containing wood preservatives often result in increased metal corrosion, for example of nails within the wood. Preserved wood products are often used in load-bearing out-door structures such as decks. Traditional fastening material, including aluminum and standard galvanized fittings, are not suitable for use with wood treated with these new preservatives. Many regions are now specifying that hardware, e.g., fittings, nails, screws, and fasteners, be either galvanized with 1.85 ounces zinc per square foot (a G-185 coating) or require Type 304 stainless steel hardware. Generally, the presence of any salt will induce corrosion. We believe that the amines present in the preservatives—alkanolamines, ammonia, and the like—contribute to corrosion of metals. We also believe that another problem with the amines present in the preservatives used in soluble copper treatments is they are, or they eventually turn into, biodegradable nitrogen-containing material that can encourage certain biological attacks, particularly mildew or mold. Wood is naturally resistant to mildews in part because it contains very little fixed nitrogen. The commonly used soluble copper compounds provide nitrogen-containing nutrients (amines) which are believed to act as food-stuff that causes an increase in the presence of for example copper-resistant sapstain molds, therefore requiring additional biocides effective on sapstain molds to be added to protect the external appearance of the wood.

Modern organic biocides are considered to be relatively environmentally benign and are not expected to pose the problems associated with CCA-treated lumber. The organic biocide is typically a triazole, a quaternary amine, or a nitroso-amine. U.S. Pat. No. 4,929,454 discloses a method for preserving wood material and rendering wood material resistant to biological deterioration by impregnating the wood material with an aqueous ammoniacal wood-treating composition containing copper, and/or zinc, and quaternary ammonium compounds. Also, oil-soluble second biocides, such as a copper(II)-sulfited tannin extract complex (epicatechins), can be dissolved in light oils, emulsified in water, and injected into the wood, as is disclosed in U.S. Pat. No. 4,988,545. Biocides such as tebuconazole are quite soluble in common organic solvents, while others such as chlorothalonil possess only low solubility. Biocides with good solubility can be dissolved at high concentrations in small amounts of organic solvents to provide an organic solution that can be dispersed in water with appropriate emulsifiers to produce an aqueous emulsion. The emulsion can then be used in conventional pressure treatments for lumber and wood to provide a wood product, in which the treated wood will come into contact with humans, such as decking.

The primary factor, however, in the selection of a wood preservative is almost always cost. The market is accustomed to the low cost and effectiveness of small concentrations of aqueous CCA, and the market is not ready to bear the incremental costs of large amounts of copper over that previously used, expensive fixating oils, expensive fixating anions, and other materials such as polymers, such as are described in the art. PCT patent application WO92/19429 discloses an attempt to improve soluble copper containing wood preservatives by incorporating different salts and oils. For example, Example 2, describes a method of treating an article of prepared wood by immersing it for 20 minutes in a bath of linseed oil at 180° C. containing a drier of 0.07% lead, 0.003% manganese and 0.004% calcium naphthenate, 0.3% copper naphthenate, and 0.03 zinc naphthenates as an insecticide and fungicide. Fojutowski, A.; Lewandowski, O, Zesz. Probl. Postepow Nauk Roln. No. 209: 197-204 (1978), describe fungicides comprising fatty acids with copper compounds, applied by dipping hardboard heated to 120° C. into a bath of the fungicide, also maintained at 120° C. These treatments are not practicable for a variety of reasons. “A New Approach To Non-Toxic, Wide-Spectrum, Ground-Contact Wood Preservatives, Part I. Approach And Reaction Mechanisms,” HOLZFORSCHUNG Vol. 47, No. 3, 1993, pp. 253-260, asserts that copper soaps, made with the carboxylic acid groups from unsaturated fatty acids of non-toxic vegetable oils, rosin, and synthetic unsaturated polyester resins have effectiveness and long-term durability as ground contact wood preservatives for use against termites and fungal attack. These are not yet in widespread use and are expected to have high leach rates and the bio-available fatty acids are expected to encourage some mold growth. Japanese Patent Application 08-183,010 JP, published in 1996, describes a modified wood alleged to have mildew-proofing and antiseptic properties and anti-proofing properties, made by treating wood with a processing liquid containing a copper salt and linseed oil or another liquid hardening composition. U.S. Pat. No. 3,837,875 describes a composition for cleaning, sealing, preserving, protecting and beautifying host materials, such as wood, containing a mixture of boiled linseed oil, turpentine, pine oil, a dryer, and 28 parts per million of metallic copper. Feist and Mraz, Forest Products Lab, Madison Wis., Wood Finishing: Water Repellents and Water-Repellent Preservatives. Revision, Report Number-FSRN-FPL-0124-Rev (NTIS 1978) discloses preservatives containing a substance that repels water (usually paraffin wax or related material), a resin or drying oil, and a solvent such as turpentine or mineral spirits. Addition of a preservative such as copper naphthenate to the water repellent is asserted to protect wood surfaces against decay and mildew organisms. Soviet Union Patent No. SU 642166 describes a wood surface staining and preservation treatment that involves impregnating wood with an aqueous copper salt solution followed by thermal treatment in boiling drying oil containing 8-hydroxyquinoline dye. U.S. published application 20030108759 describes using a copper ammonium acetate complex and a drying oil as a wood preservative. Again, oil is not favored as it can alter burning characteristics of wood, can be staining and/or discoloring, and can be an irritant. Oil is also difficult to work with and to inject into wood. None of these methods has found commercial acceptance. U.S. Pat. No. 6,521,288 describes adding certain organic biocides to polymeric nanoparticles and claims benefits including: 1) protecting the biocides during processing, 2) having the ability to incorporate water-insoluble biocides, 3) having a polymer component that acts as a diluent to provide a more even distribution of the biocide than that obtained with the prior art method of incorporating small particles of the biocide into wood, 4) reducing leaching through the use of nanoparticles, and 5) protecting the biocide within the polymer from environmental degradation. The only tests reported showed no reduction in leaching, and polymeric nanoparticles are too expensive to be used as a wood preservative. Citation of any reference above is not to be construed as an admission that such reference is prior art to the present application.

None of the above methods of preserving wood have met commercial acceptance. Accordingly, a need exists for new methods of preserving wood substrates, particularly methods that use a soluble copper-amine complex-containing wood preservative, to overcome the aforementioned limitations.

### SUMMARY OF THE INVENTION

We have surprisingly found that lowering the pH of aqueous copper-monoethanolamine complex-containing compositions to predetermined levels, e.g., from about 7.2 to about 8.2, preferably from about 7.5 to 8.0, promotes the formation of crystalline copper-containing materials which provide lower leaching rates than do fixed copper-amine complexes. The addition of acid also allows a greater amount of the ammonia and/or monoethanolamine to be removed from the wood during drying, and the ammonia and/or monoethanolamine removed will result in less ammonia and/or monoethanolamine remaining in the wood to promote corrosion and to promote growth of copper-resistant molds.

In one embodiment the present invention provides a method for preserving a wood material comprising:

(i) preparing an aqueous solution comprising a copper-alkanolamine complex;

(ii) adjusting the pH of the aqueous solution comprising a copper-alkanolamine complex to a value ranging from about 7.5 to 8.0; and

(iii) injecting the pH adjusted aqueous solution comprising a copper-alkanolamine complex into a wood material. Advantageously, a portion of the water and un-fixed alkanolamine are subsequently removed by drying, for example kiln drying, vacuum drying, microwave-assisted drying, air drying, or combinations thereof.

In another embodiment the present invention provides a method for preserving a wood material comprising:

(i) preparing an aqueous solution comprising a copper-ammonia complex;

(ii) adjusting the pH of the aqueous solution comprising a copper-ammonia complex to a value ranging from about 7.5 to 8.0; and

(iii) injecting the pH adjusted aqueous solution comprising a copper-ammonia complex into a wood material.

In another embodiment the present invention also relates to a method for preserving wood materials comprising:

(i) preparing an aqueous solution comprising a copper-alkanolamine complex;

(ii) adjusting the pH of the aqueous solution comprising a copper-alkanolamine complex to a pH value that causes the formation of a copper salt precipitate to provide a suspension of a copper salt precipitate; and

(iii) injecting the suspension of a copper salt precipitate into the wood material.

In another embodiment the present invention also relates to a method for preserving wood materials comprising:

(i) preparing an aqueous solution comprising a copper-ammonia complex;

(ii) adjusting the pH of the aqueous solution comprising a copper-ammonia complex to a pH value that causes the formation of a copper salt precipitate to provide a suspension of a copper salt precipitate; and

(iii) injecting the suspension of a copper salt precipitate into the wood material.

While written for the commercially available copper(II)-ammonia formulation and the copper(II)-monoethanolamine formulation, the method above is usable without undue experimentation on corresponding copper(I)-ammonia and copper(I)-monoethanolamine formulations. The method is also useful without undue experimentation on other formulations containing other copper(I)-amine complexes.

If a wood composite is being manufactured, the composition need not be injected but can be applied to the wood fibers.

To form a suspension of copper salts, the pH is advantageously adjusted to a pH between about 6.5 and about 7.5. Generally, it is desirable to not precipitate large quantities of copper salts and/or copper oxides prior to injecting the composition into the wood, so the pH is preferably adjusted from about 6.9 to about 7.4, preferably from about 7 to about 7.4, for example between 7.1 and 7.3. While any acid can be used to adjust the pH of the aqueous solution, certain mineral acids are preferred.

### DETAILED DESCRIPTION OF THE INVENTION

As used herein, the term “copper-amine complex” is intended to include copper(II)-alkanolamine complexes, copper(II)-ammonium complexes, copper(I)-alkanolamine complexes, copper(I)-ammonium complexes, and complexes with other amines which form stable aqueous complexes with copper.

The present invention provides a method for preserving a wood substrate with a copper-containing compound that reduces leaching of copper from the wood substrate. The invention involves fixing within the wood substrate a precipitated copper salt from a composition comprising a copper-amine complex, e.g., a copper(II)-alkanolamine complex such as the preferred copper(II)-monoethanolamine complex. The precipitated copper salt can be formed in situ, i.e., within the wood matrix after the solution containing a copper-amine complex is injected into the wood, or the precipitated copper salt can be formed ex situ, i.e., formed in the solution prior to the copper-amine complex being injected into the wood.

In a preferred embodiment, the present invention provides a method for preserving a wood substrate with a copper-containing compound that reduces leaching of copper from the wood substrate, by fixing within the wood substrate a precipitated copper salt from a composition comprising a copper(II)-monoethanolamine complex. The precipitated copper salt can be formed in situ, i.e., within the wood matrix after the solution containing a copper-monoethanolamine complex is injected into the wood, or the precipitated copper salt can be formed ex situ, i.e., formed in the solution prior to the copper-monoethanolamine complex being injected into the wood.

A first aspect of the invention is a method of preserving a wood substrate comprising preparing an aqueous solution comprising a copper-alkanolamine complex; adjusting the pH of the aqueous solution comprising a copper-alkanolamine complex to a value ranging from about 7.2 to about 8.1, preferably from about 7.5 to 8.0; and injecting the pH adjusted aqueous solution comprising a copper-alkanolamine complex into the wood substrate. If a wood composite is being manufactured, the composition need not be injected but can be applied to the wood fibers.

For copper-alkanolamine complexes, the alkanolamine preferably comprises monoethanolamine, diethanolamine, or isopropanolamine, and more preferably is monoethanolamine (“MEA”). One of ordinary skill in the art will readily recognize other alkanolamines that form complexes that can be used in methods of the invention. Examples of other alkanolamines that can be used in the methods of the invention include, but are not limited to: diglycolamine; 2-(N-methylamino) ethanol (“monomethyl ethanolamine”); 2-[(2-aminoethyl)-(2-hydroxyethyl)-amino]-ethanol; triethanolamine; N-aminoethyl-N′-hydroxyethyl-ethylenediamine; N,N′-dihydroxyethyl-ethylenediamine; 2-[2-(2-aminoethoxy)-ethylamino]-ethanol; 2-[2-(2-aminoethylamino)-ethoxy]-ethanol; 2-[2-(2-aminoethoxy)-ethoxy]-ethanol; tertiarybutyldiethanolamine; diisopropanolamine; n-propanolamine; isobutanolamine; 2-(2-aminoethoxy)-propanol; 1-hydroxy-2-aminobenzene; or the like, or any combination thereof including especially combinations with one or more of the preferred alkanolamines. The method is also usable with formulations containing other copper-amine complexes, for example a copper-aspartic acid complex or a copper-ethylenediamine complex.

In the most preferred embodiment, MEA is the alkanolamine compound, and the copper in the wood treatment formulation prior to adding acid consists essentially of copper(II)-monoethanolamine complex. In another preferred embodiment, the copper in the wood treatment formulation prior to adding acid consists essentially of a copper(II)-ammonia complex. The aqueous solutions containing the copper(II)-alkanolamine complex or the copper(II)-ammonia complex can be prepared by methods well known to those skilled in the art. For example, an aqueous copper(II)-monoethanolamine complex can be prepared using the methods disclosed in U.S. Pat. No. 6,646,147, the contents of which are incorporated herein in their entirety.

Typically, the concentration of the copper-amine complex in the aqueous solution of the copper-amine complex is sufficient to provide a copper concentration of about 0.1% to 2% by weight. In one embodiment, the concentration of the copper-alkanolamine complex is sufficient to provide a copper concentration that ranges from about 0.25% to 1.5% (w/v). In one embodiment, the concentration of the copper-alkanolamine complex is sufficient to provide a copper concentration that ranges from about 0.5% to 1% (w/v). The copper-alkanolamine complex in the aqueous solution, however, can be manufactured as a stable solution in concentrations up to about 11 percent copper(II) and can be formulated and shipped, optionally with a second biocide, as a solution with a copper concentrations of less than 10%, for example copper concentrations of about 8 or 9%, which is then diluted prior to formulating the pH adjusted aqueous solution comprising a copper-alkanolamine complex that is applied to or injected into the wood substrate in the method of the invention.

The pH of the aqueous solution of the copper-alkanolamine complex can be adjusted using any acid known to those skilled in the art. Adding acid incrementally with stirring or circulation is preferred to avoid reaching a pH below about 7 during the admixing. Representative acids include, but are not limited to, sulfuric acid, nitric acid, hydrochloric acid, phosphoric acid, phosphorous acid, boric acid, ascorbic acid, acetic acid, and propionic acid. Preferably, the acid is an inorganic acid. When an organic acid is used to adjust the pH, the organic acid is preferably a C₁ to C₃ carboxylic acid, so that the salt is advantageously quickly removed during drying and during passage of water through the wood matrix. In a preferred embodiment, the acid is boric acid, as residual boric acid itself has a biocidal effect.

Typically, the pH adjusted aqueous solution comprising a copper-alkanolamine complex is applied to the wood under vacuum or pressure using a standard apparatus used in the wood treating industry. Preferably, the pH adjusted aqueous solution comprising a copper-alkanolamine complex penetrates the wood.

Without wishing to be bound by theory it is believed that the pH adjusted aqueous solution comprising a copper-alkanolamine complex, just before, or just after it is injected into the wood, forms a precipitated copper salt that is sufficiently insoluble in water that leaching of the precipitated copper salt from the wood is reduced. In the absence of the complex, an unsatisfactory gel forms immediately. Without wishing to be bound by theory, it is believed that by applying the aqueous solution comprising a copper-alkanolamine complex as a pH adjusted aqueous solution comprising a copper-alkanolamine complex, i.e., having a pH ranging from about 7.5 to 8, allows the precipitated copper salt to form in the wood material. Without wishing to be bound by theory, it is believed that the presence of the copper-alkanolamine complex allows the formation of discrete particles of the precipitated copper salt that can be evenly distributed through out the wood substrate. In the presence of the amine, the precipitation appears to be more controlled, and crystalline salts or, more probably crystalline oxides, form and adhere in the wood matrix. However, the precipitated copper salt is still toxic to the organisms that are responsible for the decay of wood. Presumably, the precipitated copper salt, although sufficiently insoluble in water to reduce leaching, has enough solubility in water that it is still toxic to organisms that are responsible for the decay of wood. In one embodiment, it is believed that the precipitated copper salt is copper (II) hydroxide.

Advantageously, the pH adjusted aqueous solution comprising a copper-alkanolamine complex is a solution, not a slurry or a gel. Slurries and gels, when applied to the wood substrate, can block pores or vesicles of the wood and thereby make it more difficult for the preservative to penetrate the wood. The pH should be controlled so that the copper does not precipitate until the preservative is injected into the wood. Furthermore, solutions are easier to apply to the wood substrate than are slurries and gels.

It is believed that without adjusting the pH to the desired value by adding acid, a copper-amine complex is fixed in the wood. If acid is added to a composition of copper ions, i.e., without the copper-alkanolamine complex, this results in the formation of a gel like material of indefinite composition and of limited color stability rather than a precipitate.

In one embodiment, the pH adjusted aqueous solution comprising a copper-alkanolamine complex further comprises a second biocide. Biocides typically used in copper containing wood preservatives are well known to those skilled in the art. Representative second biocides include, but are not limited to, triazoles, quaternary amines, and nitroso-amines. Acids can increase the solubility of these materials in the aqueous carrier.

A second aspect of the invention relates to a method of preserving a wood substrate comprising preparing an aqueous solution comprising a copper-alkanolamine complex; adjusting the pH of the aqueous solution comprising a copper-alkanolamine complex to a pH value that causes the formation of a copper salt precipitate to provide a suspension of a copper salt precipitate; and injecting or applying the suspension of a copper salt precipitate to the wood substrate. The precipitation must be tightly controlled, as if particles grow too large the slurry will plug the wood face and the wood will not be sufficiently treated. Any of the copper-alkanolamine and copper-amine complexes discussed above can be used to prepare the aqueous solution comprising the copper-alkanolamine complex. Typically, the concentration of the copper-alkanolamine complex in the aqueous solution comprising the copper-alkanolamine complex is sufficient to provide a copper concentration that ranges from about 0.1 to 2 percent (w/v or by weight). In one embodiment, the concentration of the copper-alkanolamine complex is sufficient to provide a copper concentration that ranges from about 0.25 to 1.5 percent (w/v). In one embodiment, the concentration of the copper-alkanolamine complex is sufficient to provide a copper concentration that ranges from about 0.5 to 1 percent (w/v). The pH of the aqueous solution comprising a copper-alkanolamine complex is adjusted to a pH value of less than about 7.5 to cause the copper salt to precipitate and provide the suspension of a copper salt precipitate. Generally, the adjustment of pH should occur quickly and within minutes before the material is to be injected into wood. If the pH adjustment is slow, and/or if the slurry is allowed to age, for example, an hour or more at a pH below 7.5 before the slurry is injected into wood, then there will be relatively large crystalline copper material particulates formed and these particulates will settle out of the slurry before injection. In a most preferred embodiment, the pH is adjusted from its initial value to the desired pH within 5 minutes or less, and once the pH is adjusted the solution or slurry is then injected into the wood within five minutes, preferably within two minutes.

It can be seen that much tighter control is needed of the entire process if the copper precipitation is to commence prior to injecting the copper-amine composition into the wood. At pH 6.5, precipitation of basic copper salts, hydroxides, or oxides is rapid. At pH of 6.8, precipitation is slower. At pH of 7, depending on the copper-amine concentration, precipitation may not commence for minutes. At pH 7.1, it may be possible to commence injection of the solution into the wood prior to significant precipitation of copper salts and/or oxides. In one embodiment, the pH of the aqueous solution comprising a copper-alkanolamine complex is adjusted to a pH of less than about 7.25 to cause the copper salt to precipitate and provide the suspension of a copper salt precipitate. In one embodiment, the pH of the aqueous solution comprising a copper-alkanolamine complex is adjusted to a pH value of less than about 7.1 to cause the copper salt to precipitate and provide the suspension of a copper salt precipitate.

The acid may be added to the copper-amine composition as a solid or as a liquid, depending on the acid. Certain methods of adding acid confer added benefit. A portion of the acid may be added to the wood surface. Generally, it is advisable that not all acid be added this way, but rather between 5% and 20% of the acid needed to get to the desired pH can be coated on the wood. For example, the acid may, at least in part, comprise boric acid and, for example, finely divided boric acid particulates may be added to the composition just prior to injection, or may be sprayed or coated on the wood. The boric acid particles may plate out or adhere to wood surfaces and as the copper-amine composition is injected into the wood dissolution of the boric acid and lowering of the pH will occur as the copper-amine composition is being injected into the wood.

In one embodiment, the pH of the aqueous solution comprising a copper-alkanolamine complex is adjusted to a pH value of between about 6.5 and 7.5 to cause the copper salt to precipitate and provide the suspension of a copper salt precipitate. In one embodiment, the pH of the aqueous solution comprising a copper-alkanolamine complex is adjusted to a pH value of between about 6.75 and 7.25 to cause the copper salt to precipitate and provide the suspension of a copper salt precipitate. In one embodiment, the pH of the aqueous solution comprising a copper-alkanolamine complex is adjusted to a pH value of between about 6.8 and 7.2 to cause the copper salt to precipitate and provide the suspension of a copper salt precipitate. In one embodiment, the pH of the aqueous solution comprising a copper-alkanolamine complex is adjusted to a pH value of between about 6.9 and 7.1 to cause the copper salt to precipitate and provide the suspension of a copper salt precipitate. In one embodiment, the pH of the aqueous solution comprising a copper-alkanolamine complex is adjusted to a pH value of about 7 to cause the copper salt to precipitate and provide the suspension of a copper salt precipitate. The pH of the aqueous solution comprising a copper-alkanolamine complex can be adjusted using any of the acids described above.

In a preferred embodiment, at least 99% by weight of the particulates have a diameter of less than 1 micron, for example less than 0.6 microns. The particle size can be determined by Stokes law in an inert fluid, such as a light alkane. The term average particle size, as used herein, means a particle size determined by a technique that is based on Stoke's Law, i.e., sedimentation. For example, the particle size can be measured using a Analysette 20 (commercially available from Laval Lab Inc. of Quebec, Canada). Generally, the average particle size is defined as the size where 50% by weight of the material has a larger or equal diameter, and 50% by weight of the material has a smaller diameter. If the average size is less than about 0.4 microns, the average size is sufficiently small. The problem is that a small fraction of precipitated particles have a size several times the average diameter. A smaller average diameter, however, implies the maximum size of the larger particulates will be smaller. In one embodiment, the average particle size of the copper salt precipitate in the suspension of a copper salt precipitate is less than about 200 nanometers. In one embodiment, the average particle size of the copper salt precipitate in the suspension of a copper salt precipitate is less than about 175 nanometers. In one embodiment, the average particle size of the copper salt precipitate in the suspension of a copper salt precipitate is less than about 150 nanometers. In one embodiment, the average particle size of the copper salt precipitate in the suspension of a copper salt precipitate is less than about 125 nanometers. In one embodiment, the average particle size of the copper salt precipitate in the suspension of a copper salt precipitate is less than about 100 nanometers. In one embodiment, the average particle size of the copper salt precipitate in the suspension of a copper salt precipitate ranges from about 50 nanometers to 200 nanometers. In one embodiment, the average particle size of the copper salt precipitate in the suspension of a copper salt precipitate ranges from about 75 nanometers to 150 nanometers. In one embodiment, the average particle size of the copper salt precipitate in the suspension of a copper salt precipitate ranges from about 80 nanometers to 125 nanometers. In one embodiment, the average particle size of the copper salt precipitate in the suspension of a copper salt precipitate ranges from about 90 nanometers to 110 nanometers. In one embodiment, the average particle size of the copper salt precipitate in the suspension of a copper salt precipitate is about 100 nanometers.

When the average particle size of the copper salt precipitate in the suspension of a copper salt is within the above-identified size range, the particles are sufficiently small that they can penetrate the pores of a wood substrate when the suspension of a copper salt is applied to the wood substrate. The suspension of a copper salt can be applied to the wood using any method well known to those skilled in the art. Typically, the suspension of a copper salt is applied to the wood under vacuum or pressure using a standard apparatus used in the wood treating industry. Preferably, the copper salt (or basic copper salt or copper oxide or copper hydroxide) penetrates the wood. Advantageously, when the average particle size of the copper salt precipitate is within the above-identified size range, the copper salt can penetrate the wood substrate homogenously to protect the entire portion of the wood substrate. Another advantage of the average particle size of the copper salt precipitate being within the above-identified size range is that particles of this size are less visible than larger particles. This is especially true for particles wherein the average particle size of the copper salt precipitate is about 100 nanometers.

Without wishing to be bound by theory, it is believed that the copper salt precipitate is sufficiently insoluble in water that leaching of the copper salt precipitate from the wood is reduced. Surprisingly, however, the copper salt precipitate is still toxic to the organisms that are responsible for the decay of wood. Presumably, the copper salt precipitate, although sufficiently insoluble in water to reduce leaching, has enough solubility in water that it is still toxic to organisms that are responsible for the decay of wood. In one embodiment, it is believed that the copper salt precipitate is copper (II) hydroxide. In one embodiment, the suspension of a copper salt precipitate further comprises a second biocide. Biocides typically used in copper containing wood preservatives are well known to those skilled in the art. Representative second biocides include, but are not limited to, those described above. Advantageously, it is believed that the copper salt precipitate acts as an adsorbent for the second biocide, which can be dissolved in the suspension of a copper salt precipitate or present as an emulsion. Absorbing the second biocide on the copper salt precipitate assures that the second biocide also penetrates the wood in a homogenous fashion.

### EXAMPLES

The following examples illustrate the methods of the invention.

### Example 1

Applying a pH Adjusted Aqueous Solution Comprising a Copper-Alkanolamine Complex to Wood that Forms a Precipitate within the Wood.

A copper monoethanolamine complex is produced as disclosed in the US published patent application no. 20030162986 to Richardson and Zhao or by the dissolution of copper carbonate in monoethanolamine solutions. This solution is then diluted with water to a nominal copper concentration of between 0.5 and 1.0 percent and the pH of the solution is adjusted to a value between 7.5 to 8.0 with an acid such as dilute sulfuric acid. Alternately, the acid can be added continuously to the water prior to dilution, to better mix the acid and the copper-amine composition. The resulting solution is injected into a wood substrate under vacuum or pressure using a standard apparatus used in the wood treating industry.

### Example 2

Applying a Copper Salt Precipitate to Wood.

A copper monoethanolamine complex is produced as disclosed in US published patent application no. 20030162986 to Richardson and Zhao or by the dissolution of copper carbonate in monoethanolamine solutions. This solution is then diluted with water to a nominal copper concentration of between 0.5 and 1.0 percent and the pH of the solution is adjusted with acid until a precipitate begins to form. A dispersant can be added to the resulting slurry to increase the amount of time that the precipitate will remain suspended. The resulting solution is injected into a wood substrate under vacuum or pressure using a standard apparatus used in the wood treating industry. Applying the slurry to the wood substrate may require longer times than in Example 1.

The present invention is not to be limited in scope by the embodiments disclosed in the Examples that are intended as illustrations of a few aspects of the invention, and any embodiments that are functionally equivalent are within the scope of this invention. Indeed, various modifications of the invention in addition to those shown and described herein will become apparent to those skilled in the art and are intended to fall within the scope of the appended claims.

What is claimed is:

1. A method for preserving a wood substrate, comprising:
providing an aqueous preservative composition comprising a soluble copper complex selected from the group consisting of soluble copper-monoethanolamine complex, a soluble copper-ammonia complex, or a mixture thereof;
adding at least one acid to reduce the pH of the aqueous preservative composition to a value ranging from about 6.5 to about 8; and
injecting the pH-adjusted aqueous preservative composition into the wood substrate,
wherein the pH-adjusted aqueous preservative composition is injected in an amount sufficient to provide at least 0.1 percent by weight of solubilized copper to the wood substrate.

2. The method of claim 1, wherein the pH-adjusted aqueous preservative composition has a pH ranging from about 7.2 to about 8.1, and wherein the pH-adjusted aqueous preservative composition is injected in an amount sufficient to provide at least 0.25 percent by weight of solubilized copper to the wood substrate.

3. The method of claim 1, wherein the pH-adjusted aqueous composition has a pH of from about 7.5 to about 8.0.

4. The method of claim 1, further comprising the step of drying the wood substrate injected with the pH-adjusted aqueous composition to remove water, monoethanolamine, ammonia, or both, wherein the quantity of monoethanolamine and/or ammonia removed from the wood substrate is greater than the amount of monoethanolamine and/or ammonia that would be removed if the wood substrate was injected by a composition that did not have the pH adjusted.

5. The method of claim 2, wherein a copper salt is precipitated from the pH-adjusted aqueous composition after the composition has been injected into the wood substrate.

6. The method of claim 5, wherein a copper hydroxide material is precipitated from the pH-adjusted aqueous composition after the composition has been injected into the wood substrate.

7. The method of claim 2, wherein a basic copper salt is precipitated from the pH-adjusted aqueous composition after the composition has been injected into the wood substrate.

8. The method of claim 2, wherein the acid is selected from the group consisting of sulfuric acid, hydrochloric acid, phosphoric acid, phosphorous acid, nitric acid, boric acid, ascorbic acid, acetic acid, propionic acid, and combinations thereof.

9. The method of claim 2, wherein the acid comprises boric acid.

10. The method of claim 3, wherein the acid comprises boric acid.

11. The method of claim 2, wherein the acid comprises citric acid.

12. The method of claim 2, wherein the acid comprises acetic acid.

13. The method of claim 2, wherein the acid comprises phosphoric acid.

14. The method of claim 3, wherein the pH-adjusted aqueous composition further comprises a biocide.

15. A method for preserving a wood substrate, said method comprising:
preparing an aqueous preservative solution comprising a soluble copper complex selected from the group consisting of a copper-alkanolamine complex, a copper-ammonia complex, or both;
adding at least one acid to adjust the pH of the aqueous solution comprising the copper complex to a value ranging from about 7.2 to 8.1; and
injecting the pH adjusted aqueous preservative solution comprising a copper-alkanolamine complex onto and/or into a wood substrate, wherein there is no measurable precipitation of copper salts from the pH-adjusted aqueous solution prior to injection, and wherein a copper salt is precipitated from the pH-adjusted aqueous composition after the composition has been injected into the wood substrate,
wherein the pH-adjusted aqueous preservative solution is injected in an amount sufficient to provide from about 0.1% to 2% by weight of solubilized copper in the wood substrate.

16. The method of claim 15, further comprising the step of drying to remove water and a portion of the alkanolamine, a portion of the ammonia, or both, wherein the quantity of alkanolamine and/or ammonia removed from the wood substrate is greater than the amount of monoethanolamine and/or ammonia that would be removed if the wood substrate was injected by a composition that did not have the pH adjusted.

17. The method of claim 15, wherein the aqueous preservative solution comprises a copper-alkanolamine complex.

18. The method of claim 15, wherein a copper hydroxide material is precipitated from the pH-adjusted aqueous composition after the composition has been injected into the wood substrate.

19. The method of claim 15, wherein a basic copper salt is precipitated from the pH-adjusted aqueous composition after the composition has been injected into the wood substrate.

20. The method of claim 15, wherein the acid is selected from the group consisting of sulfuric acid, hydrochloric acid, phosphoric acid, phosphorous acid, nitric acid, boric acid, ascorbic acid, acetic acid, propionic acid, and combinations thereof.

21. The method of claim 15, wherein the acid comprises boric acid, and wherein the pH adjusted aqueous preservative solution comprises an amount of copper-alkanolamine complex and/or copper-ammonia complex in an amount sufficient to provide from about 0.25% by weight of solubilized copper in the wood substrate.

22. The method of claim 15, wherein the pH-adjusted aqueous composition further comprises a second biocide.

23. A method for preserving a wood substrate, said method comprising:
providing an aqueous solution comprising a soluble copper complex selected from the group consisting of a soluble copper complex selected from the group consisting of a copper-alkanolamine complex, a copper-ammonia complex, or both,
adding at least one acid to adjust the pH of the aqueous solution comprising the copper complex to a value that causes the formation of an injectable copper salt precipitate, thus creating an aqueous suspension of a copper salt precipitate; and
injecting the pH adjusted copper salt suspension into a wood substrate,
wherein the pH-adjusted copper salt suspension is injected in an amount sufficient to provide at least about 0.1% by weight of solubilized copper in the wood substrate.

24. The method of claim 23, wherein the pH is adjusted to a value ranging from about 6.5 to about 7.5.

25. The method of claim 24, wherein the pH is adjusted to a value ranging from about 6.75 to about 7.25.

26. The method of claim 25, wherein the pH is adjusted to a value ranging from about 7 to about 7.3.

27. The method of claim 23, wherein the pH-adjusted aqueous composition further comprises a biocide, wherein a portion of the biocide adheres to the precipitate.

28. The method of claim 23, further comprising the step of drying to remove water and a portion of the alkanolamine, a portion of the ammonia, or both, wherein the quantity of alkanolamine and/or ammonia removed from the wood substrate is greater than the amount of monoethanolamine and/or ammonia that would be removed if the wood substrate was injected by a composition that did not have the pH adjusted.

29. The method of claim 23, wherein the acid is selected from the group consisting of sulfuric acid, hydrochloric acid, phosphoric acid, phosphorous acid, nitric acid, boric acid, ascorbic acid, acetic acid, propionic acid, and combinations thereof.

30. The method of claim 23, wherein the copper salt suspension comprises particulates, at least 99% by weight of which have an average diameter determined by Stokes Law in water of less than 0.6 microns.

31. The method of claim 30, wherein the copper salt suspension comprises particulates, at least 99% by weight of which have an average diameter determined by Stokes Law in water of less than 0.4 microns.

32. The method of claim 31, wherein the copper salt suspension comprises particulates, at least 99% by weight of which have an average diameter determined by Stokes Law in water of less than 0.2 microns.

33. A method for preserving a wood substrate, said method comprising:
providing an aqueous composition comprising a soluble copper-monoethanolamine complex;
adding an acid to adjust the pH of the aqueous composition comprising the soluble copper monoethanolamine complex to a value ranging from about 7.5 to 8.0; and
injecting the pH-adjusted aqueous composition into a wood substrate,
wherein the pH-adjusted aqueous composition is injected in an amount sufficient to provide between 0.5% and 2.0% by weight of solubilized copper in the wood substrate.

34. The method of claim 33, wherein the acid is sulfuric acid.

35. The method of claim 33, wherein the acid is phosphoric acid.

36. The method of claim 33, wherein the acid is boric acid.

37. A method for preserving a wood substrate, said method comprising:
preparing an aqueous solution comprising a copper-monoethanolamine complex;
adding an acid to adjust the pH of the aqueous solution to a value between 6.5 and 7.4, wherein a copper salt precipitate forms, thus creating an aqueous suspension of an injectable copper salt precipitate; and
injecting the pH adjusted copper salt suspension into a wood substrate,
wherein the pH-adjusted copper salt suspension is injected in an amount sufficient to provide between 0.5% and 2.0% by weight of solubilized copper in the wood substrate.

38. The method of claim 37, wherein the copper salt suspension comprises particulates, at least 99% by weight of which have an average diameter determined by Stokes Law in water of less than 0.4 microns.

38. The method of claim 37, wherein the copper salt suspension further comprises an organic biocide.

39. A wood substrate made according to the method of claim 1.

40. A wood substrate made according to the method of claim 23.

41. A wood substrate made according to the method of claim 33.

42. A wood substrate made according to the method of claim 37.
